(19) United States
(12) Patent Application Publication
(10) Pub. No.: US 2026/0192386 A1
(43) Pub. Date: Jul. 9, 2026

(54) TWO-STEP LASER WELDING OF METAL FOIL STACK TO METAL SUBSTRATE

(71) Applicant: Rofin-Sinar Laser GmbH, Hamburg (DE)

(72) Inventors: Peter KALLAGE, Hamburg (DE); Oliver FORSTER, Güster (DE)

(73) Assignee: Rofin-Sinar Laser GmbH, Hamburg (DE)

(21) Appl. No.: 19/013,840

(22) Filed: Jan. 8, 2025

(51) Int. Cl. B23K 26/08; B23K 26/06; B23K 26/0622; B23K 26/21; B23K 101/18; B23K 103/10

(52) U.S. Cl. CPC B23K 26/083; B23K 26/0604; B23K 26/0622; B23K 26/21; B23K 2101/18; B23K 2103/10

(57) ABSTRACT

A method for laser welding a stack of metal foils to a metal substrate includes first interconnecting the metal foils with a first laser-weld joint by serially tracing a plurality of paths on the side of the stack, and then connecting the stack of interconnected metal foils to the metal substrate by oscillating-beam welding. The oscillating-beam welding includes modulating the travel speed of the laser beam, and optionally also the laser beam power, along the path of the oscillation pattern. This method allows for the oscillation pattern to span across the entire height of the foil stack and onto the substrate, while depositing energy at a rate that is commensurate with the structural properties of the material irradiated by the laser beam at any given time during the oscillating-beam welding process. The method thereby forms a strong and robust connection between the foil stack and the substrate.

### TECHNICAL FIELD

The present invention relates in general to laser welding of a stack of metal foils to a metal substrate, in particular as applied to the production of electrochemical batteries such as lithium-ion batteries.

### DISCUSSION OF BACKGROUND ART

Beams of laser-radiation are increasingly used to weld a wide range of materials including metals and metal alloys. In laser welding, a focused laser beam locates each weld spot or seam precisely, while minimizing collateral heating and minimizing unwanted defects. It is useful to distinguish two main laser welding regimes. Conduction welding occurs at lower laser powers and lower power densities. Absorbed laser power heats the irradiated material, melting material in each part to be joined. The melted material flows, mixes, and then solidifies. Keyhole welding occurs at higher laser powers and higher power densities that are sufficient to vaporize some of the irradiated material. The pressure of the vaporized material on surrounding melted material opens a channel, termed a “keyhole”, through the melted material. This keyhole has a characteristic narrow and deep profile, which allows deep penetration of the laser beam. Finished keyhole welds are generally narrower, deeper, and stronger than conduction welds.

Lithium-ion batteries are the critical enabling technology for portable electronic devices, electric vehicles, and most other contemporary rechargeable electrical devices. Each cell of a battery includes two stacks of thin metal foils that are immersed in or coated with an electrolyte that contains lithium salt. The metal is most often aluminum or copper, and the foils have a typical thickness of about 10 micrometers (μm). There are typically 20 to 40 individual foils in each foil stack. Foil stacks may be rolled into cylinders or lie flat. Each foil stack is electrically connected to a metal tab that protrudes from the cell for electrical connection. The metal tab thickness usually exceeds the foil thickness by a factor of about ten or more. Multiple cells are electrically connected to form a battery, in series and/or in parallel, depending on the voltage and current requirements of the electrical device. Multiple batteries may be electrically connected, in series and/or in parallel, to form a battery pack.

The mechanical attachment and electrical connection of each foil to the respective tab is critical for the integrity, reliability, and performance of the battery. However, joining many thin metal foils to a much thicker metal tab is challenging. The completed joint must be strong, durable, and have low electrical resistance. Precision resistance welding is used but relies on interface resistance, and the high thermal conductivity of the metals to be welded means that a high current must be applied. Ultrasonic welding is the most widely used technique but contaminants between foils are an issue in the welded area. If not removed, these contaminants can weaken the weld joint. Laser welding has emerged as an attractive alternative, providing precise delivery of power to minimize overall heat accumulation, while the high laser intensity vaporizes contaminants.

International Patent Application Publication Number WO 2022/179760 discloses a method for laser welding a stack of metal foils to a metal substrate. This method disclosed in WO 2022/179760 is useful in the manufacture of battery cells, for example lithium-ion battery cells, where the method may be used to weld a stack of anode or cathode metal foils to a metal tab for electrical connection. The method disclosed in WO 2022/179760 is a two-step process that circumvents the difficulties of welding together materials with highly disparate thicknesses in a single laser-welding operation.

In the method disclosed in WO 2022/179760, a first laser welding step interconnects the metal foils with a first laser-weld joint by serially tracing a plurality of lateral paths, along the metal foil edges, with a laser beam. This first laser welding step welds the metal foils to each other in a relatively gentle manner that is commensurate with the relatively thin metal foils and thus prevents spatter and excessive curling and/or cracking of the metal foils. This first laser welding step serves to both electrically interconnect the metal foils and structurally strengthen the metal foil stack. Next, a second laser welding step connects the stack of interconnected metal foils to the metal substrate by tracing a path along the interface between the first laser-weld joint and the metal-substrate surface. The second laser welding step benefits from the improved strength of the welded metal foil stack provided by the first laser-weld joint that interconnects the metal foils. Therefore, the second laser welding step can utilize more powerful laser welding to connect the pre-welded stack of thin metal foils to the relatively thick metal substrate with a robust and high-quality weld joint. The first laser welding step may rely solely on conduction welding, whereas the second laser welding step may utilize keyhole welding.

### SUMMARY

Disclosed herein is a method for laser welding a stack of metal foils to a metal substrate in two laser welding steps, the second of which utilizes a sophisticated oscillating-beam welding technique. This method is suitable for laser welding a stack of anode or cathode metal foils to a metal tab in a battery cell, such as a lithium-ion battery cell. The presently disclosed method is an improvement over the method disclosed in WO 2022/179760, wherein the second laser welding step is applied to a larger portion of the first laser-weld joint, as opposed to a region more local to the interface between the first laser-weld joint and the substrate. The present method thereby forms an even stronger and more robust connection between the foil stack and the substrate. In order to address a larger portion of the first laser-weld joint, the second laser welding step of the present method employs an oscillating-beam welding technique tailored to the dissimilar structural properties encountered as the laser beam is incident on different portions of the substrate-foil stack assembly. Specifically, as the laser beam traces the oscillation pattern, the travel speed, and optionally also a power, of the laser beam is adjusted according to where the laser beam is incident on the assembly. This variation allows for extending the oscillation pattern across the entire height of the foil stack and onto the substrate, while depositing energy at a rate that is commensurate with the structural properties of the material affected by the laser beam at any given time during the oscillating-beam welding process.

In one aspect of the invention, a method for laser welding a stack of metal foils to a metal substrate includes disposing the stack of metal foils on a surface of the metal substrate such that a side of the stack, formed by edges of the metal foils, is located on an interior portion of the surface of the metal substrate. The stack of metal foils and the metal substrate form an assembly. The side of the stack has a lengthwise dimension parallel to an interface between the stack and the metal substrate. The method further includes interconnecting the metal foils with a first laser-weld joint by serially tracing a plurality of paths on the side of the stack with a first laser beam, and connecting the stack of interconnected metal foils to the metal substrate by oscillating-beam welding. The oscillating-beam welding includes concurrent steps of (a) directing a second laser beam onto the assembly, (b) oscillating an incidence location, of the second laser beam on the assembly, about a first location while scanning the first location along the lengthwise dimension of the side of the stack, such that a path traced by the incidence location repeatedly crosses the side of the stack and the interface, and (c) modulating travel speed of the incidence location, along the path, such that a first travel speed attained when the incidence location is on the metal substrate is lower than a second travel speed attained when the incidence location is on the stack.

### BRIEF DESCRIPTION OF THE DRAWINGS

The accompanying drawings, which are incorporated in and constitute a part of the specification, schematically illustrate preferred embodiments of the present invention, and together with the general description given above and the detailed description of the preferred embodiments given below, serve to explain principles of the present invention.

FIG. 1 illustrates a metal foil stack-substrate assembly prepared for laser welding, according to an embodiment. FIG. 1 depicts an exemplary scenario where the metal foil stack-substrate assembly is part of a battery assembly.

FIG. 2 is a flowchart for a method for laser welding the stack of metal foils to the metal substrate in the metal foil stack-substrate assembly of FIG. 1, according to an embodiment. The method includes two sequential laser welding steps.

FIG. 3 illustrates a metal foil stack-substrate assembly where the side of the metal foil stack, subjected to laser welding in the method of FIG. 2, is slanted, according to an embodiment.

FIGS. 4A-4D illustrate one embodiment of the first laser welding step, of the FIG. 2 method, that interconnects the stack of metal foils with a first laser-weld joint.

FIG. 5 illustrates an embodiment of the second laser welding step of the FIG. 2 method. This second laser welding step connects the stack of metal foils, already interconnected by the first laser-weld joint, to the metal substrate.

FIG. 6 illustrates an exemplary oscillation pattern for oscillating-beam welding the stack of metal foils, interconnected by the first laser-weld joint, to the metal substrate in the FIG. 2 method. The oscillation pattern includes a series of loops.

FIG. 7 illustrates a zig-zag pattern for oscillating-beam welding the stack of metal foils, interconnected by the first laser-weld joint, to the metal substrate in an embodiment of the FIG. 2 method.

FIG. 8 illustrates the transverse profile of a composite laser beam that is useful for performing the laser welding of the FIG. 2 method, according to an embodiment.

FIG. 9 illustrates the second laser welding step of the FIG. 2 method in further detail, in an example where the foil stack-substrate assembly has a slanted side.

FIG. 10 illustrates a modulated oscillating-beam welding method that may be implemented in an embodiment of the second laser welding step of the FIG. 2 method.

FIG. 11 illustrates examples of travel speed modulation and optional power modulation in the second laser welding step of the FIG. 2 method.

FIG. 12 illustrates another embodiment of the first laser welding step, of the FIG. 2 method, that interconnects the stack of metal foils with a first laser-weld joint.

### DETAILED DESCRIPTION

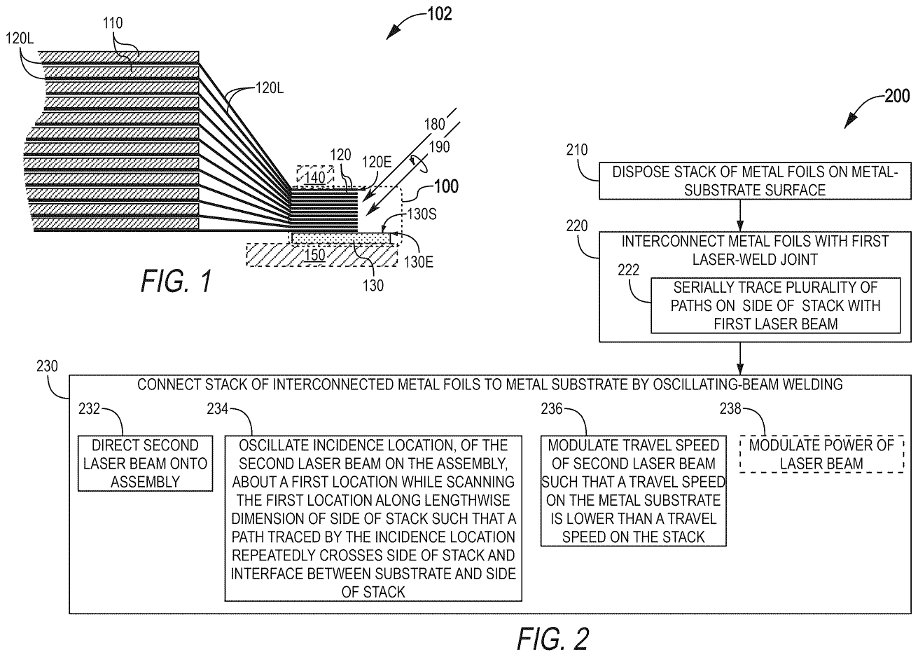

Referring now to the drawings, wherein like components are designated by like numerals, FIG. 1 illustrates, in cross-sectional side view, one metal foil stack-substrate assembly 100 prepared for laser welding. Foil stack-substrate assembly 100 includes a plurality of metal foils 120 stacked on a metal substrate 130. In the depicted exemplary scenario, foil stack-substrate assembly 100 is part of a battery assembly 102 during a battery manufacturing process. In this scenario, foils 120 stacked on substrate 130 are distal portions of larger foils 120L having material layers 110 disposed thereon, and each foil 120 is a distal portion of a respective foil 120L that extends beyond material layers 110 to reach substrate 130. Each material layer 110 may include an electrolyte, such as a lithium salt, and foils 120L form either a set of anodes or a set of cathodes of a battery cell. When implemented in battery assembly 102, substrate 130 is a metal tab, and laser welding of foils 120 to substrate 130 serves to for an electrical connection therebetween.

The thickness of each foil 120 may be in the range between 5 and 30 micrometers (μm). For comparison, the thickness of substrate 130 may be in excess of 0.5 millimeters (mm). Foil stack-substrate assembly 100 may include 10 or more foils 120 stacked on substrate surface 130S, for example between 20 and 40 foils 120. Foils 120 are for example made of aluminum, and substrate 130 may be made of aluminum or an aluminum alloy. Alternatively, substrate 130 may be made of another metal or metal alloy, such as copper, a copper alloy, or a steel alloy. In another example, foils 120 are made of copper, and substrate 130 may be made of copper, a copper alloy, or another metal.

FIG. 2 is a flowchart for one method 200 for laser welding the stack of foils 120 to substrate 130. FIG. 2 is best viewed together with FIG. 1. Method 200 may serve to electrically connect each foil 120 to substrate 130. Method 200 includes steps 210, 220, and 230. Step 210 forms foil stack-substrate assembly 100, with the stack of foils 120 to be laser welded to substrate 130 in two sequential laser welding steps 220 and 230. Step 220 interconnects the stack of foils 120 with a first laser-weld joint formed by a laser beam 180 incident on the side of the stack of foils 120. Step 230 then connects the interconnected stack of foils 120 to substrate 130 by laser welding with a laser beam 190. This two-step laser welding process allows for (a) first interconnecting the relatively fragile foils 120 in a suitably gentle manner and (b) subsequently, while benefitting from the added mechanical strength provided by the first laser-weld joint, joining the stack of foils 120 to substrate 130 with a strong and robust laser welded connection.

Step 210 disposes the stack of foils 120 on a surface 130S of substrate 130. Edges 120E of foils 120 form a side of the stack that is located on an interior portion of substrate surface 130S, i.e., a non-zero distance away from the perimeter 130E of substrate surface 130S. Foils 120 may be secured between substrate 130 and a removable clamp 140. When utilized, removable clamp 140 is set back from the side of the stack formed by edges 120E by, e.g., between 0.1 and 5 mm. This setback not only improves laser-beam access to the stack of foils 120 but also allows for foils 120 to undergo some amount of shrinkage during laser welding. In certain embodiments of method 200, step 210 clamps substrate 130 and foils 120 between removable clamp 140 and a backing plate 150.

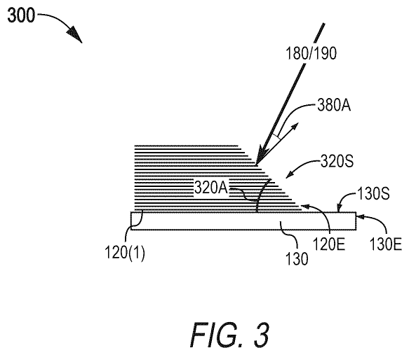

FIG. 3 is a cross-sectional view of one metal foil stack-substrate assembly 300 where the side of the metal foil stack, subjected to laser welding in method 200, is slanted. Although depicted as being straight in FIG. 3, the slanted side may be curved and/or irregular. Foil stack-substrate assembly 300 is an embodiment of foil stack-substrate assembly 100, wherein the interior angle 320A between substrate surface 130S and the side 320S of the stack of foils 120 is less than 90 degrees. Angle 320A may be in the range between 10 and 80 degrees or, more preferably, between 20 and 50 degrees. The slant resulting from angle 320A being less than 90 degrees may be advantageous for the laser welding processes performed by laser beams 180 and 190 in steps 220 and 230, respectively.

A slanted configuration allows for the laser beam, in each of steps 220 and 230, to be incident along a direction that is at an oblique angle with respect to substrate surface 130S, for example approximately normal to side 320S. In one example, the incidence angle 380A of laser beam 180 and/or laser beam 190, relative to a surface normal of side 320S is between −20 degrees and +20 degrees. Such near-normal incidence of laser beam 180/190 onto side 320S may optimize the coupling of energy from laser beam 180/190 to foils 120. The slanted configuration also increases the area accessible for laser welding, thus allowing for the formation of a stronger laser-weld joint. Furthermore, laser welding of foil edges 120E in the slanted configuration handles shrinkage of foils 120 particularly well. Shrinkage may occur when foils 120 are heated by laser welding, especially when first interconnecting foils 120 in step 220.

Embodiments of foil stack-substrate assembly 100 where the side of the stack of foils 120 is not slanted (as shown in FIG. 1) correspond to angle 320A being 90 degrees. In such embodiments, the normal vector to side 320S is parallel to substrate surface 130S, and incidence angle 380A of laser beam 180/190 may be at least 20 degrees.

Referring again to FIG. 2, one embodiment of step 210 achieves a slanted side 320S by offsetting the edges 120E of foils 120 from each other such that edge 120E of each non-bottom foil 120 is located on an interior portion of the adjacent lower foil 120. In other words, edges 120E are offset from each other such that, generally, the higher a foil 120 is in the stack, the farther the corresponding edge 120E is set back with respect to edge 120E of the bottom foil 120(1). It is understood that imperfections may lead to deviations from this pattern. For example, side 320S may be generally slanted even if a few non-bottom foils 120 extend beyond the respective adjacent lower foil 120. However, on average in the slanted configuration, each edge 120E is set back from the edge 120E of any immediately adjacent lower foil 120 by an offset. This offset may be less than 200 μm (for example in the range between 20 and 200 μm) as averaged over all the metal foils in the stack.

As used herein, the terms “top”, “bottom”, “up”, “down”, “upper”, and “lower” do not imply a particular relationship to the direction of gravity. Rather, these terms are relative to substrate 130. For example, “bottom” foil 120(1) is the foil that is closest to substrate surface 130S, and the “top” of the stack of foils 120 is the surface of the stack farthest away from substrate surface 130S.

Another embodiment of step 210 arranges foils 120 such that side 320S is orthogonal to substrate surface 130S, as depicted for the stack of foils 120 in FIG. 1.

Step 220 is a first laser-welding step that interconnects foils 120 with a first laser-weld joint. Step 220 includes a step 222 of serially tracing a plurality of paths on the side of the metal-foil stack with laser beam 180. These traces weld edges 120E of foils 120 to each other. Step 220 operates on foils 120 that are relatively thin and does not attempt to weld these thin foils 120 to the thicker substrate 130. Therefore, step 220 may relatively gently weld together foils 120 to avoid undesirable outcomes, such as excessive curling and/or cracking of foils 120 as well as significant loss of material caused by spatter. Step 220 may rely solely on conduction welding to avoid such undesirable outcomes. Once step 220 is completed, the first laser-weld joint not only electrically interconnects foils 120 but also provides mechanical strength.

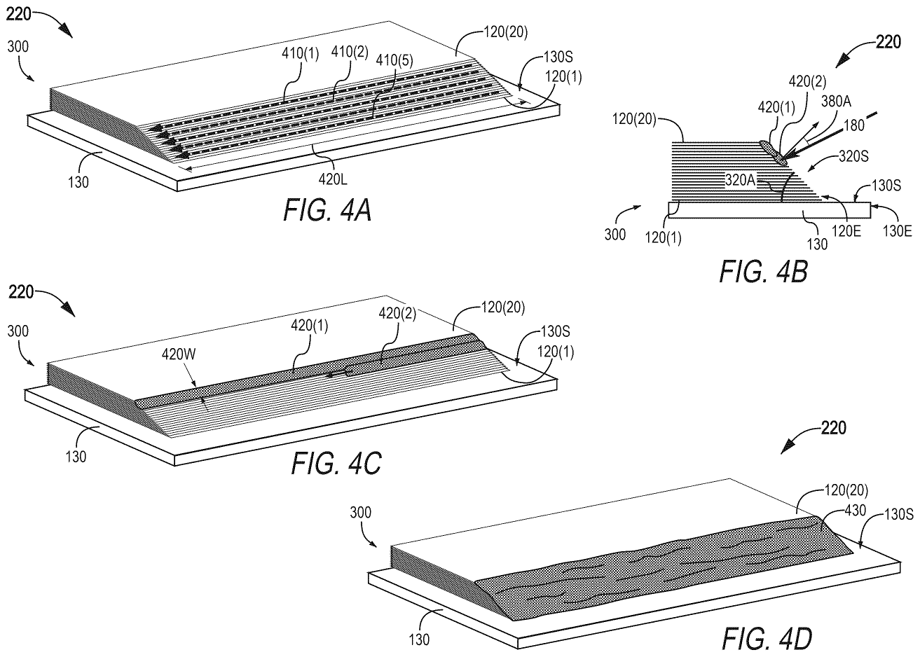

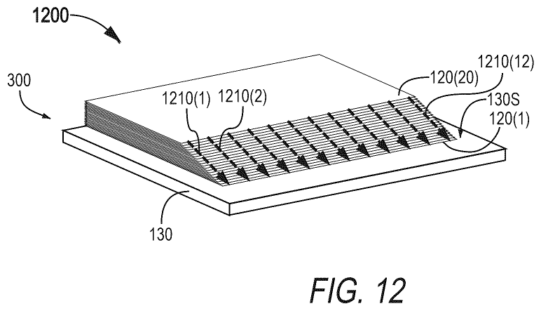

FIGS. 4A-4D illustrate step 220 of method 200, as applied to foil stack-substrate assembly 300. Step 220 may, more generally, be applied to foil stack-substrate assembly 100 with the side of the stack of foils 120 being slanted (as shown in FIGS. 3 and 4A-D) or not slanted (as shown in FIG. 1). The example depicted in FIGS. 4A-4D has twenty foils 120, enumerated 120(1) through 120(20), with foil 120(1) being closest to substrate surface 130S and foil 120(20) farthest from substrate surface 130S. FIG. 4A illustrates one exemplary configuration of paths traced by the laser beam 180 in step 220. Other path configurations are possible, and one other example is discussed below in reference to FIG. 12. FIGS. 4B and 4C depict, in cross-sectional side view and in perspective view, respectively, the state of foil stack-substrate assembly 100 at one stage during step 220. FIG. 4D depicts the completed first laser-weld joint formed by step 220.

In step 220, laser beam 180 traces a plurality of paths 410 (see FIG. 4A), for example between 3 and 20 paths 410. In the depicted path configuration, each path 410 is a lateral path that runs parallel to edges 120E. Laser beam 180 first traces a lateral path 410(1) farthest from substrate surface 130S. Each subsequent lateral path 410 is closer to substrate surface 130S than any preceding lateral path 410. The final lateral path 410 (the fifth lateral path 410(5) in the example depicted in FIG. 4A) is closest to substrate surface 130S. Each lateral path 410 may span the full length 420L of edges 120E, or a significant fraction thereof. Laser beam 180 may trace each lateral path 410 in the same direction, for example as indicated by the arrows in FIG. 4A, or laser beam 180 may trace some lateral paths 410 in mutually opposite directions. In one example, successive lateral paths 410 are traced in opposite directions, forming an overall continuous trace having a serpentine shape. As indicated in FIGS. 4B and 4C, each tracing of a lateral path 410 by laser beam 180 forms a weld line 420. Each weld line 420 may have a width 420W in the range between 15 μm and 1 mm. After formation of a first weld line 420(1), each subsequent weld line 420 touches or overlaps with at least the immediately preceding weld line 420. Thus, upon completion of step 220, all edges 120E have been laser-welded together to form a common first laser-weld joint 430 as shown in FIG. 4D. Laser beam 180 may be configured to perform only conduction welding and avoid keyhole formation in step 220.

In an alternative embodiment, laser beam 180 traces paths 410 in a different order, for example with the reverse tracing order starting nearest substrate surface 130S with lateral path 410(5) and finishing with lateral path 410(1), or at least partly out of order. Laser beam 180 may even interleave the tracing of different lateral paths 410. Laser beam 180 may also trace paths arranged in a different configuration than that depicted in FIG. 4A-C, provided that the resulting weld lines touch or overlap to ultimately form first laser-weld joint 430.

Referring again to FIGS. 1 and 2, step 230 of method 200 is a second laser welding step that uses oscillating-beam welding to connect the stack of foils 120 with substrate 130. At this stage, foils 120 are already interconnected by the first laser-weld joint formed in step 220. Benefitting from the mechanical strength provided by this first laser-weld joint, step 230 may utilize keyhole welding. Step 230 includes concurrent steps 232 and 234. Step 232 directs laser beam 190 to foil stack-substrate assembly 100. Step 234 moves the incidence location of laser beam 190, on foil stack-substrate assembly 100, in an oscillation pattern. Herein, an “incidence location” refers to the location where the center of a laser beam is incident on a workpiece.

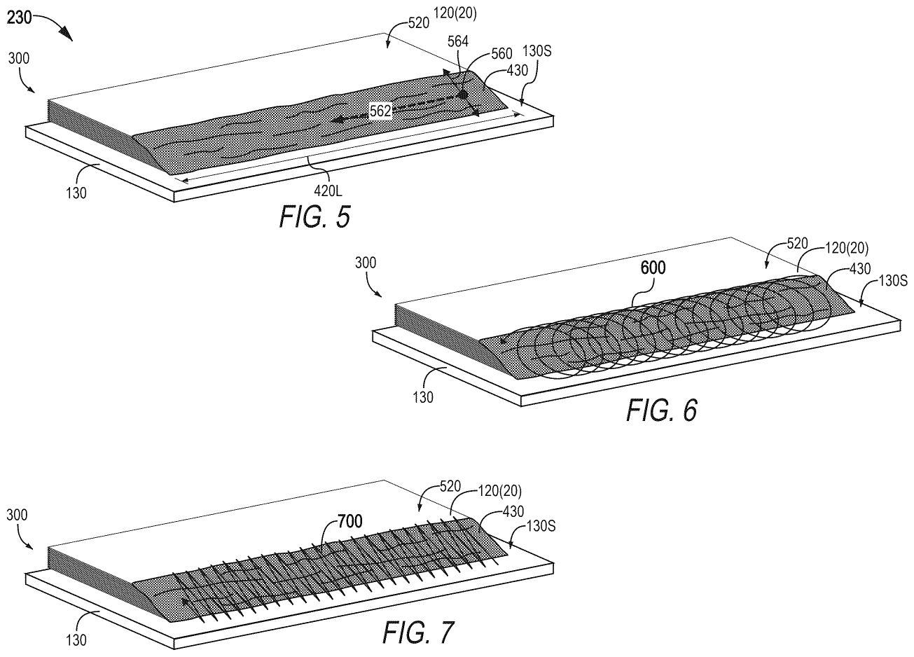

FIG. 5 illustrates step 234 of method 200, as applied to foil stack-substrate assembly 300 with first laser-weld joint 430. Step 234 may, more generally, be applied to foil stack-substrate assembly 100 with the side of the stack of foils 120 being slanted (as shown in FIGS. 3 and 5) or not slanted (as shown in FIG. 1). Step 234 (a) oscillates the incidence location about a location 560 as indicated by double arrow 564, while (b) scanning location 560 along a lengthwise dimension of the side of the stack of foils 120 as indicated by arrow 562. The lengthwise dimension is parallel to length 420L and to edges 120E of foils 120 (see FIGS. 1 and 3). The path traced by the incidence location thereby repeatedly crosses the side of the foil stack and the interface between the foil stack and the substrate. The motion imparted by step 234 forms an oscillation pattern on foil stack-substrate assembly 100/300. Herein, an “oscillation pattern” refers to the pattern traced by the incidence location, on foil-stack substrate assembly 100, through the combined actions of (a) oscillating the incidence location about a first location and (b) scanning the first location. In most embodiments, it is sufficient to perform a single scan of location 560 along the lengthwise dimension of the side of the stack of foils 562. The scan speed of location 560 may be constant.

Referring now to FIGS. 2 and 5 in combination, during the oscillating-beam welding effected by steps 232 and 234, a step 236 modulates the travel speed of the incidence location along the path traced by the incidence location. The travel speed is modulated to attain a relatively low value on substrate 130 and a relatively high value on the stack of foils 120.

Optionally, step 230 further includes a step 238 performed concurrently with steps 232, 234, and 236. Step 238 modulates a power of laser beam 190 such that the laser power is relatively low whenever the incidence location is on the top 520 of the stack of foils 120 (see FIG. 5). In one embodiment, the laser power utilized whenever the incidence location is on top 520 is lower than the laser power attained when the incidence location is on substrate 130 and, in some embodiments, on a lower half of the side of the stack of foils 120.

The laser parameter modulation in step 236, and step 238 if included, controls the rate of energy delivery along the oscillating-beam welding path on foil stack-substrate assembly 100 according to the properties of the material subjected to laser irradiation at any given time. For example, substrate 130 is relatively thick and can therefore tolerate a relatively high rate of energy delivery. In fact, a high rate of energy delivery may be necessary to form a weld nugget with a desired penetration depth into substrate 130. The stack of foils 120 is typically more fragile, even when interconnected by first laser-weld joint 430, and a lower rate of energy delivery is therefore more suitable. Top 520 of the stack of foils 120 may be the most sensitive part of foil stack-substrate assembly 100, especially at locations outside first laser-weld joint 430.

FIG. 6 illustrates one oscillation pattern 600 for oscillating-beam welding the stack of foils 120, interconnected by the first laser-weld joint, to substrate 130. Oscillation pattern 600 is one example of the motion of the laser-beam incidence location imparted by step 234 of method 200. When tracing oscillation pattern 600, the incidence location of laser beam 190 travels along a series of loops. For example, the incidence location of laser beam 190 may perform an approximately circular or elliptical motion about location 560 while location 560 is scanned as indicated by arrow 562 in FIG. 5.

FIG. 7 illustrates another oscillation pattern 700 for oscillating-beam welding the stack of foils 120, interconnected by the first laser-weld joint, to substrate 130. Oscillation pattern 700 is another example of the motion of the laser-beam incidence location imparted by step 234 of method 200. Oscillation pattern 700 is a zig-zag pattern. Oscillation pattern 700 may be achieved by translating the incidence location up and down from location 560 while scanning location 560 as indicated by arrow 562 in FIG. 5.

Each of oscillation patterns 600 and 700 may instead be applied to embodiments of foil stack-substrate assembly 100 where the side of the stack of foils 120 is not slanted (as shown in FIG. 1). Oscillation patterns 600 and 700 are only examples of the oscillation patterns that may be imparted by step 234 of method 200. Other oscillation patterns may be utilized, including sinusoidal and rectangular patterns.

The oscillation pattern traced by the laser-beam incidence location in step 234 extends from substrate 130, across the interface between substrate 130 and the stack of foils 120, up the side of the stack of foils 120 to top 520. The oscillation pattern may extend onto top 520 by some amount. In one embodiment, the oscillation pattern extends beyond first laser-weld joint 430 on top 520. In another embodiment, the oscillation pattern does not extend beyond the first laser-weld joint generated in step 220. Due to the non-zero transverse extent of laser beam 190, the actual area irradiated by laser beam 190 extends beyond the oscillation pattern traced by the laser-beam incidence location. Thus, even when the oscillation pattern traced by the incidence location is within first laser-weld joint 430, laser beam 190 may irradiate an area outside first laser-weld joint 430.

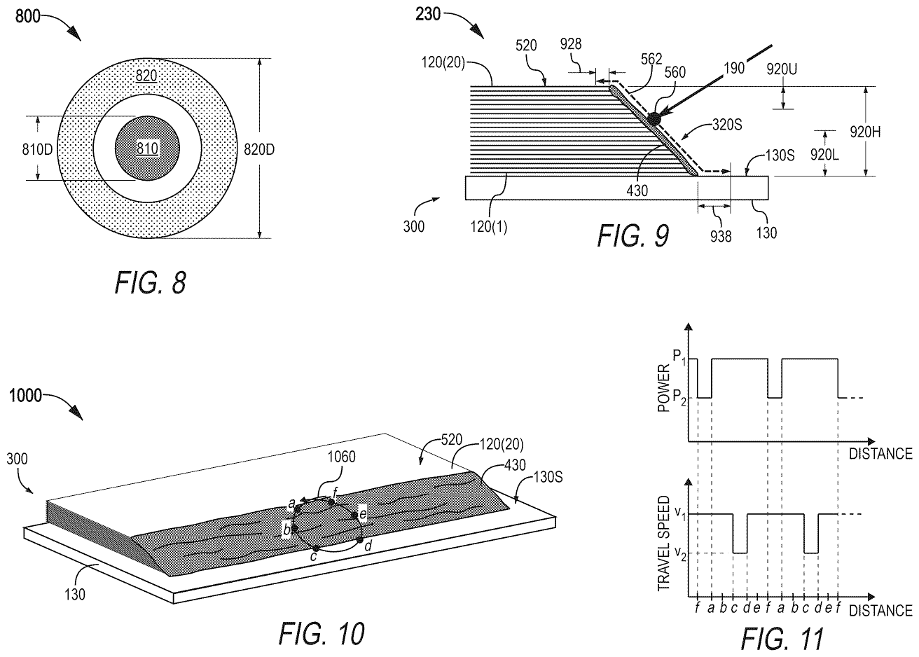

FIG. 8 illustrates the transverse profile of one composite laser beam 800 that may be used to perform either or both of laser welding steps 220 and 230 of method 200. Composite beam 800 includes a center beam 810 and a surrounding annular beam 820. As composite beam 800 is traced along a path on foil stack-substrate assembly 100, annular beam 820 may help (a) precondition the material for more powerful irradiation by center beam 810 and (b) control the cooling rate after passage of center beam 810.

Center beam 810 may have a 1/e² diameter 810D in the range between 15 and 100 μm. Annular beam 820 may have an outer 1/e² diameter 820D in the range between 100 and 500 μm. For comparison, the distance from the substrate surface 130S to top 520 of the stack of foils 120, across the side of the foil stack, may be in the range between 0.2 and 6 mm.

A local minimum in laser intensity may exist between center beam 810 and annular beam 820. Composite beam 800 may be generated by a fiber laser, such as the ARM fiber laser from Coherent Corp. of Saxonburg, Pennsylvania. Alternatively, the single laser beam generated by a standard fiber laser may be manipulated, e.g., with refractive and/or diffractive optics, to form composite beam 800.

In one scenario, composite beam 800 performs both step 220 and step 230 of method 200. In step 220, the laser source may be operated with no or only insignificant power in center beam 810 and perform conduction welding with annular beam 820 only. Here, annular beam 820 may be a continuous-wave beam with a power in the range between 50 and 1000 watts. Alternatively, the respective average powers of center beam 810 and annular beam 820 may be selected such that center beam 810 and annular beam 820 have the same maximum intensity. In this case, center beam 810 and annular beam 820 may both be continuous-wave beams and have a combined power in the range between 50 and 1000 watts. In step 230, center beam 810 may be pulsed, while annular beam 820 is a continuous-wave beam. As composite beam 800 traces a path on foil stack-substrate assembly 100, step 236 may modulate the travel speed of composite beam 800, along this path, by 25% or more. For example, composite beam 800 may attain (a) a travel speed on substrate 130 in the range between 10 and 50 mm/s and (b) a travel speed of at least 5 mm/s on the stack of foils 120. In one embodiment of step 230, the laser power modulated in optional step 238 is that of annular beam 820, and the average power of center beam 810 is kept constant. In this embodiment, annular beam 820 may be a continuous-wave beam, center beam 810 may be pulsed, step 238 may modulate the power of annular beam 820 by 25% or more, and the total average power of composite beam 800 may be in range between 50 and 1000 watts.

Without departing from the scope hereof, one or both of steps 220 and 230 may utilize another type of laser beam than composite beam 800, for example a Gaussian or top-hat laser beam.

FIG. 9 illustrates step 230 of method 200 in further detail, in an example where method 200 is applied to foil stack-substrate assembly 300. When tracing the oscillation imparted by step 234, the incidence location of laser beam 190 may or may not travel beyond first laser-weld joint 430 on top 520 of the stack of foils 120. In one embodiment, the distance 928 by which the incidence location of laser beam 190 travels beyond first laser-weld joint 430 on top 520 is in the range from zero to 2000 μm. The incidence location of laser beam 190 typically, but not necessarily, travels beyond first laser-weld joint 430 onto substrate surface 130S by a non-zero distance 938. Non-zero distance 938 may be in the range between 50 and 2000 μm.

When step 230 includes step 238, the laser power subject to modulation may be (a) below a first threshold power whenever the incidence location is on top 520 and (b) above a second threshold power when the incidence location is on substrate 130 or a lower half 920L of the stack of foils 120. The second threshold power exceeds the first threshold power. Lower half 920L is half the full height 920H of the stack of foils 120. In one example, full height 920H is in the range between 0.2 and 3 mm. In one implementation, the laser power subject to modulation drops below the first threshold power at a location that is within the upper quarter 920U of the stack of foils 120. Thus, an upper portion of the side of the foil stack may experience the relatively lower power as well.

FIG. 10 illustrates one modulated oscillating-beam welding method 1000. Method 1000 is an embodiment of step 230 of method 200 and is depicted as being applied to foil stack-substrate assembly 300. Method 1000 is also applicable to embodiments of foil stack-substrate assembly 100 where the side of the stack of foils 120 is not slanted. In method 1000, the incidence location of laser beam 190 traces a series of loops 1060 on the foil stack-substrate assembly, for example to execute oscillation pattern 600. For clarity of illustration, only one loop 1060 is depicted in FIG. 10. During tracing of loop 1060, the incidence location of laser beam 190 passes through points a, b, c, d, e, and f. Points c and d are at the boundary between first laser-weld joint 430 and substrate surface 130S. Points b and e are half-way up the side of the stack of foils 120, that is, at the upper limit of lower half 920L. Points a and f are in the upper quarter 920U of the side of the stack of foils 120.

In the embodiment of step 236 implemented in method 1000, the travel speed of the laser-beam incidence location attains a lower value in the segment on substrate surface 130S between points c and d than on the stack of foils 120. The travel speed may be constant or vary along this segment from point c to point d. In one example, the travel speed (or range of travel speeds) attained on the segment from point c to point d is lower than the travel speed (or range of travel speeds) attained anywhere else.

Method 1000 may include an embodiment of step 238, whereby a power of laser beam 190 is modulated. This modulation is, for example, imposed on annular beam 820. The to-be-modulated laser power may be modulated in the following fashion: Starting with the incidence location of laser beam 190 being on top 520, the power is below the first threshold power. The power is increased to above the first threshold power, and optionally to above the second threshold power, when the incidence location reaches point a. No later than when reaching point b, the power is increased to above the second threshold power. The power remains above the second threshold power at least until the incidence location reaches point e, and optionally until reaching point f. At point f, the power is then decreased again to be below the first threshold power.

FIG. 11 illustrates examples of travel speed and optional power modulation in steps 236 and 238, respectively, of method 200. Here, travel speed is modulated between two values v1 and v2. Travel speed v1 is maintained from point d to point c of the oscillation pattern depicted in FIG. 10. Elsewhere, the travel speed is v2. The laser power, subject to modulation, is modulated between two powers P1 and P2. The laser power P1 is maintained from point a to point f. Elsewhere, the laser power is P2. The modulation of travel speed and power modulation may be performed in discrete jumps, as shown in FIG. 11. Alternatively, the modulation may be more gradual.

Method 1000 and the modulation examples depicted in FIG. 11 are readily extendable to other oscillation patterns, for example oscillation pattern 700 shown in FIG. 7.

FIG. 12 illustrates one method 1200 for interconnecting a slanted stack of metal foils with a first laser-weld joint formed by tracing a plurality of transverse paths with a laser beam. Method 1200 is an embodiment of step 220 and may be applied to the stack of foils 120 in foil stack-substrate assembly 300 (as shown) or embodiments of foil stack-substrate assembly 100 where the side of the stack is not slanted (as shown in FIG. 1). Method 1200 is an alternative to the embodiment of step 220 depicted in FIG. 4A-C, wherein laser beam 180 traces a plurality of transverse paths 1210 instead of lateral paths. Each transverse path 1210 is oriented substantially perpendicular to edges 120E of foils 120. Laser beam 180 may trace all transverse paths 1210 in the same direction, for example starting from the foil 120 most distant from substrate surface 130S and tracing in the direction towards substrate surface 130S. Alternatively, laser beam 180 may trace some of transverse paths 1210 in mutually opposite directions. For example, laser beam 180 may trace transverse paths 1210 in a continuous serpentine pattern.

In the example depicted in FIG. 12, laser beam 180 traces twelve transverse paths 1210. Without departing from the scope hereof, laser beam 180 may trace a different number of transverse paths 1210. The weld lines formed along each transverse path 1210 may overlap with weld lines formed along adjacent transverse paths 1210, so as to combine and form first laser-weld joint 430 as shown in FIG. 4D.

The present invention is described above in terms of a preferred embodiment and other embodiments. The invention is not limited, however, to the embodiments described and depicted herein. Rather, the invention is limited only by the claims appended hereto.

What is claimed is:

1. A method for laser welding a stack of metal foils to a metal substrate, comprising steps of:
disposing the stack of metal foils on a surface of the metal substrate such that a side of the stack, formed by edges of the metal foils, is located on an interior portion of the surface of the metal substrate, the stack of metal foils and the metal substrate forming an assembly, the side of the stack having a lengthwise dimension parallel to an interface between the stack and the metal substrate;
interconnecting the metal foils with a first laser-weld joint by serially tracing a plurality of paths on the side of the stack with a first laser beam; and
connecting the stack of interconnected metal foils to the metal substrate by oscillating-beam welding, said oscillating-beam welding including concurrent steps of:
directing a second laser beam onto the assembly,
oscillating an incidence location, of the second laser beam on the assembly, about a first location while scanning the first location along the lengthwise dimension of the side of the stack, such that a path traced by the incidence location repeatedly crosses the side of the stack and the interface, and
modulating travel speed of the incidence location, along the path, such that a first travel speed attained when the incidence location is on the metal substrate is lower than a second travel speed attained when the incidence location is on the stack.

2. The method of claim 1, wherein the second laser beam is a composite beam including a center beam and a surrounding annular beam.

3. The method of claim 2, wherein the center beam is a pulsed beam, and the annular beam is a continuous-wave beam.

4. The method of claim 2, wherein an outer transverse extent of the annular beam is between 100 and 500 micrometers, and a distance across the side of the stack from the metal substrate to a top of the stack, facing away from the surface of the metal substrate, is in the range between 0.2 and 6 millimeters.

5. The method of claim 1, wherein, in the step of oscillating the incidence location, the incidence location repeatedly reaches a top of the stack facing away from the surface of the metal substrate.

6. The method of claim 1, wherein the step of modulating travel speed maintains at least a threshold travel speed whenever the incidence location is on the stack, the threshold travel speed exceeding the first travel speed by at least 25%.

7. The method of claim 1, wherein the step of connecting further includes a step of modulating a power of the second laser beam such that the power is (a) below a first threshold power whenever the incidence location is on a top of the stack facing away from the metal substrate and (b) above a second threshold power when the incidence location is on the metal substrate or a lower half of the side of the stack nearest the metal substrate, the second threshold power exceeding the first threshold power.

8. The method of claim 7, wherein the first threshold power is at most 75% of the second threshold power.

9. The method of claim 7, wherein the step of modulating a power transitions the power from above the second threshold power to below the first threshold power when the incidence location is on an upper quarter of the side of the stack farthest away from the metal substrate.

10. The method of claim 7, wherein the second laser beam is a composite beam including a center beam and a surrounding annular beam, and the step of modulating a power includes modulating power of the annular beam.

11. The method of claim 10, wherein the center beam maintains a constant average-power during modulation of the power of the annular beam.

12. The method of claim 1, wherein the step of oscillating the incidence location includes tracing, with the second laser beam, a plurality of loops on the assembly, the plurality of loops being offset from each other along a path scanned by the first location.

13. The method of claim 1, wherein:
the first laser beam forms the first laser-weld joint by conduction welding; and
the second laser beam keyhole welds the stack of interconnected metal foils to the metal substrate.

14. The method of claim 13, wherein the first laser beam is an annular laser beam.

15. The method of claim 1, wherein:
the step of disposing includes offsetting the edges of the metal foils from each other such that the edge of each non-bottom one of the metal foils is located on an interior portion of an adjacent lower one of the metal foils, whereby the side of the stack is slanted; and
each of the first and second laser beams, in the steps of interconnecting and connecting, respectively is incident along a direction that is at an oblique angle with respect to the surface of the metal substrate.

16. The method of claim 15, wherein a thickness of each of the metal foils is between 5 and 30 micrometers, and wherein the step of disposing produces an average offset, between the edges of each pair of adjacent metal foils, in the range between 20 and 200 micrometers, as averaged over the stack.

17. The method of claim 1, wherein a thickness of each of the metal foils is between 5 and 30 micrometers.

18. The method of claim 17, wherein the stack includes at least ten metal foils.

19. The method of claim 17, wherein the metal foils are made of aluminum.

20. The method of claim 19, wherein the metal substrate is made of aluminum or an aluminum alloy.
